(19) United States
(12) Patent Application Publication
(10) Pub. No.: US 2009/0157999 A1
(43) Pub. Date: Jun. 18, 2009

(54) Control Mechanism For Multi-Functional Chips

(76) Inventors: Bei-Chuan Chen, Hsinchu (TW); Li-Hsiang Chan, Hsinchu (TW); Shih-Kai Huang, Hsinchu (TW)

Correspondence Address: LIN & ASSOCIATES INTELLECTUAL PROPERTY, INC., P.O. BOX 2339, SARATOGA, CA, 95070-0339, US

(21) Appl. No.: 11/955,380

(22) Filed: Dec. 12, 2007

(51) Int. Cl. G06F 12/00

(52) U.S. Cl. 711/172; 711/E12.078

(57) ABSTRACT

A control mechanism for multi-functional chips is provided. By receiving operation signals from the predefined pins of the different operation functions, the present invention accesses the corresponding storage area in the memory module according to the operation signals without using different memory modules and memory controllers corresponding to different operation functions so as to save power and reduce the hardware size. For example, the MegaSIM™ multi-functional chip includes the integration of a plurality of operation functions, such as SD/MMC and ISO 7816. Each operation function uses different communication protocol to provide operation signals through individual to shared predefined pins. For example, MegaSIM™ I/O, Vpp/CLK, GND, CLK RST, and Vcc pins are used by ISO 7816, and Cmd, Data0, and Vpp/CLK pins are used by SD/MMC.

### FIELD OF THE INVENTION

The present invention generally relates to a control mechanism, and more specifically to a control mechanism for multi-functional chips.

### BACKGROUND OF THE INVENTION

As the demands on mobile communication and information circulation increase, the convenience of data access on the communication devices, such as phone books becomes an important development issue.

The mainstream access interfaces of the current market are mainly two types, SIM interface and SD/MMC interface. In SIM interface, SIM (ISO 7816) card is a microprocessor card, which is unable to provide a large amount of storage space because of the limitation of the available storage space and the capability of the computing unit. The main function of SIM card is as the access media of the GSM system. On the other hand, SD/MMC card is the media interface of the mainstream multimedia mobile phones, and the demands are increasing because of the popularity in mobile video downloading. To meet such demands, the manufacturers have launched various types of mobile phones with external memory cards, which make the SD/MMC card a default standard of media interface for communication devices.

Most of the current communication devices use the SIM card as the communication interface, and require additional hardware, such as SD/MMC control chips and access mechanism, for using SD/MMC card as media interface for large storage space. This not only increases the manufacturing cost, but also delays the development of the product.

As SIM (ISO 7816) card is the component specific to mobile phones, the SIM card is difficult to be connected to other mobile devices. To access the file information on the SIM card, it is necessary to access through the device or network transfer. Therefore, in addition to the SIM interface and SD/MMC interface, to largely increase the storage capacity of the SIM card to meet the demands of the mobile communication, and provide convenient operation, the M-systems Corp. launched a new architecture of MegaSIM™ communication device access interface. The MegaSIM™ architecture is an integrated interface mainly based on the SIM (ISO 7816) card architecture and the SD/MMC card specification.

In addition to the SIM card architecture, the MegaSIM™ architecture provides complete communication functions and large storage space, as well as provides convenient operation mode to match the access device to reduce the hardware cost. The MegaSIM™ provides high speed interface, encryption technology and high capacity flash storage space so as to provide a secure, removable, standardized, and anytime access. All these features of the MegaSIM™ reduce the hardware cost of the multimedia mobile phones with additional SD/MMC card slot, and increase the expansive capability of the storage space on the mobile phones.

However, the MegaSIM™ can only issue a command or perform data access to a SIM card or an SD/MMC card at a time. That is, the access to the SD/MMC card cannot be issued unless the access to the SIM interface is terminated; and vice versa. This restriction poses inconvenience on the software application and the hardware control.

In fact, the MegaSIM™ architecture provides different memory modules and controllers for SIM card and SD/MMC card; such as EEPROM and related controller for SIM card and flash memory and related controller for SD/MMC card. In this architecture, as an additional memory controller is included, more physical space is used and more power is consumed. In the mean time, the storage capacity of the SIM card is still limited by the capacity of EEPROM, and the data cannot be stored to the added flash memory.

### SUMMARY OF THE INVENTION

The primary object of the present invention is to provide a control mechanism for multi-functional chips. By receiving operation signals from the predefined pins of the different operation functions, the present invention accesses the corresponding storage area in the memory module according to the operation signals without using different memory modules and memory controllers corresponding to different operation functions so as to save power and reduce the size.

Another object of the present invention is to provide a control mechanism for multi-functional chips. By adjusting the address range of each storage area in the memory module, the present invention can adjust the memory capacity used by different operation functions.

Yet another object of the present invention is to provide a control mechanism for multi-functional chips. By using the scalable flash memory as the memory module, the present invention can expand the memory capacity of the electronic device unlimitedly.

For example, the MegaSIM™ multi-functional chip includes the integration of a plurality of operation functions, such as SD/MMC and ISO 7816. Each operation function uses different communication protocol to provide operation signals through individual to shared predefined pins. For example, MegaSIM™ I/O, Vpp/CLK, GND, CLK RST, and Vcc pins are used by ISO 7816, and Cmd, Data0, and Vpp/CLK pins are used by SD/MMC.

To achieve the aforementioned objects, the present invention provides a control mechanism for multi-functional chips, including a memory module and a logic unit. The memory module is for storing data and defines a storage area corresponding to each operation function. The logic unit is electrically connected to at least one predefined pin of each operation function, respectively, and accesses the corresponding storage area in the memory module according to the received operation signal from the predefined pins of the corresponding operation function.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of an embodiment of a multi-functional chip;

FIG. 2 shows a schematic view of the control mechanism for multi-functional chips of the present invention; and

FIGS. 3A-3B show a schematic view of an embodiment of the control mechanism for multi-functional chips of the present invention.

### DETAILED DESCRIPTION OF THE PREFERRED EMBODIMENTS

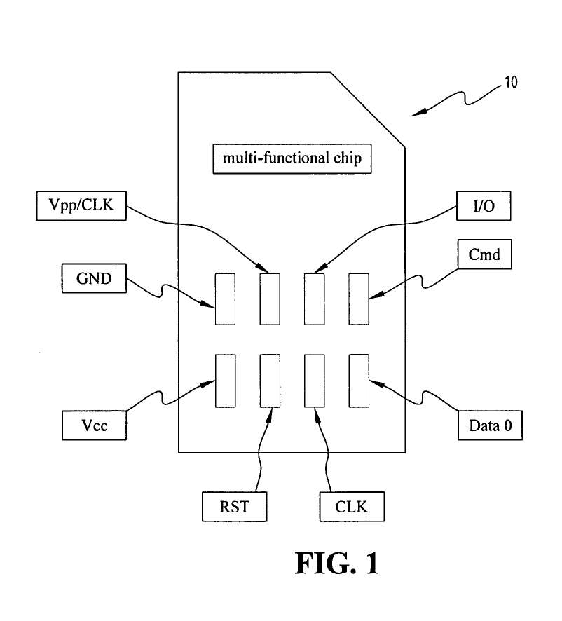

FIG. 1 shows a schematic view of an embodiment of a multi-functional chip of the present invention. As shown in FIG. 1, a MegaSIM™ multi-functional chip 10 includes a plurality of operation functions, such as SD/MCC and ISO 7816. Each operation function uses different communication protocol to provide operation signals through individual to shared predefined pins. For example, MegaSIM™ I/O, Vpp/CLK, GND, CLK RST, and Vcc pins are used by ISO 7816, and Cmd, Data0, and Vpp/CLK pins are used by SD/MMC.

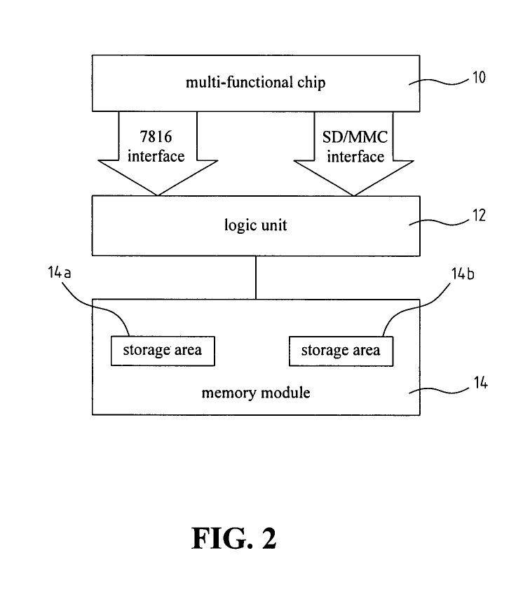

FIG. 2 shows a schematic view of a control mechanism for multi-functional chips of the present invention. As shown in FIG. 2, the control mechanism for multi-functional chips of the present invention includes a memory module 14 and a logic unit 12 for providing the data storage requirements of multi-functional chip 10. Logic unit 12 is electrically connected to at least a predefined pin of each operation function respectively so as to form the ISO 7816 interface and SD/MMC interface. For example, each operation function uses different communication protocol to provide operation signals through individual to shared predefined pins. For example, the ISO 7816 interface includes the MegaSIM™ I/O, Vpp/CLK, GND, CLK RST, and Vcc pins, and the SD/MMC interface includes the Cmd, Data0, and Vpp/CLK pins. Logic unit 12 makes the memory physical address of the predefined range in memory module provided to ISO 7816 and SD/MMC operation functions so as to define storage areas 14a, 14b corresponding to ISO 7816 and SD/MMC operation function.

It is worth noting that in addition to the individual or shared pins, the SD/MMC interface and ISO 7816 interface of multi-functional chip 10 can further electrically connect to USB interface and further include a micro control unit (MCU), RAM, ROM and a logic unit responsible for controlling SD/MMC and ISO 7816 interfaces. The logic unit includes an algorithm responsible for memory access by the communication device through SD/MCC and ISO 7816 interfaces.

In other words, the control mechanism for multi-functional chip of the present invention can access the corresponding storage areas 14a, 14b in memory module 14 according to the operation signal from the predefined pins of different operation functions without having different memory module and memory controller for each different operation function. This achieves the objects of power saving and the size reduction of the device. In the mean time, the original independent control mechanisms required by the two interfaces can be replaced by the present invention so that only a single control mechanism is required to issue commands or access data to both ISO 7816 and SD/MMC interfaces.

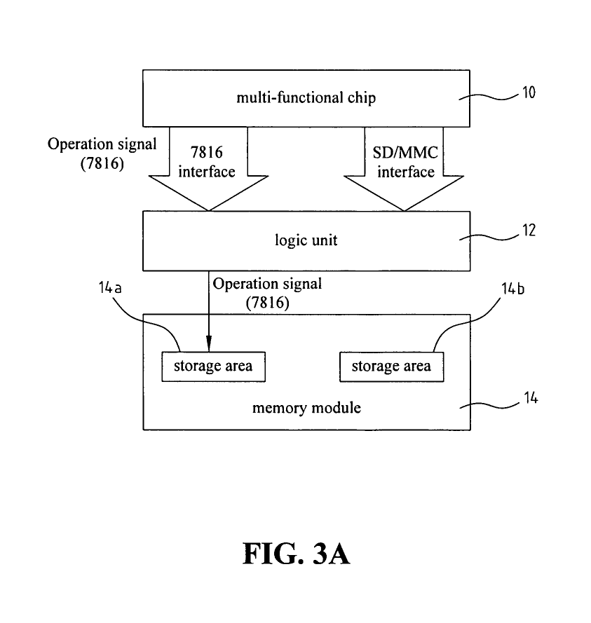

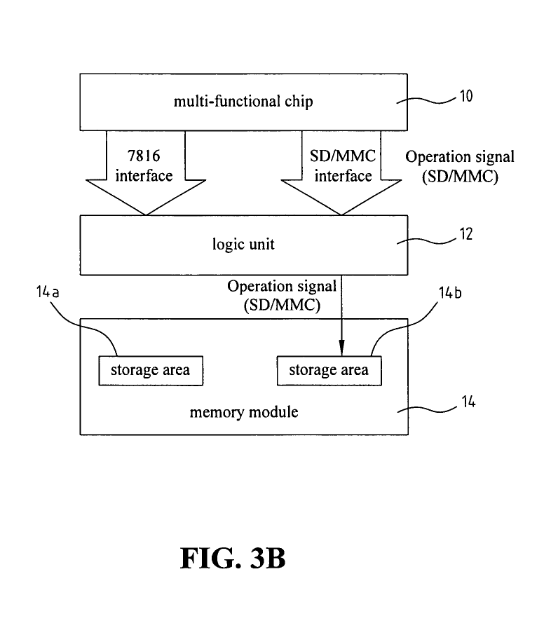

FIGS. 3A-3B show a schematic view of an embodiment of the control mechanism for multi-functional chips of the present invention. As shown in FIGS. 3A-3B, the present invention includes a memory module 14 and a logic unit 12.

As shown in FIG. 3A, when the communication device having the control mechanism for multi-functional chips of the present invention intends to access memory module 14 through ISO 7816 interface, the algorithm of logic unit 12 will map the input data to the physical address of memory module 14, i.e., storage area 14a. In other words, all the data transmission through ISO 7816 interface will be to and from within the specified physical address range. For example, when through ISO 7816 interface, the algorithm of logic unit 12 will assign the physical address ranging from 0x0D to 0x0F. When storing or accessing, the algorithm will store to or access from the physical address range. On the other hand, the area outside of the physical address range is reserved to the SD/MMC interface.

As shown in FIG. 3B, when accessing memory module 14 through the SD/MMC interface, the algorithm of logic unit 12 will map the input data to the physical address of memory module 14, i.e., storage area 14b. In other words, all the data transmission through SD/MMC interface will be to and from within the specified physical address range. For example, when through SD/MMC interface, the algorithm of logic unit 12 will assign the physical address ranging from 0x00 to 0x0C. When storing or accessing, the algorithm will store to or access from the physical address range.

When the SD/MMC interface requires to expand the storage capacity, logic unit 12 can be used to adjust the physical address ranges of each storage area 14a, 14b in memory module 14 so that different operation function can use different memory capacity.

In summary, the algorithm of the control mechanism for multi-functional chips of the present invention includes the integration of the two interfaces and uses the flash memory as the storage module for both interfaces so that both ISO 7816 and SD/MMC interfaces will access the data within the specific physical address ranges according to the algorithm.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A control mechanism for multi-functional chips, said multi-functional chip integrating a plurality of operation functions, with each operation function using different communication protocol to provide operation signal through individual or shared predefined pins, said control mechanism comprising:
a memory module, for storing data, and defining a storage area corresponding to each said operation function; and
a logic unit, electrically connected to at least a said predefined pin corresponding to each said operation function respectively, and accessing said corresponding storage area in said memory module according to said operation signal received from said predefined pin corresponding to the said operation function.

2. The control mechanism as claimed in claim 1, wherein when said multi-functional chip is MegaSIM™, said plurality of operation functions at least comprise SD/MMC and ISO 7816.

3. The control mechanism as claimed in claim 1, wherein said logic unit makes the memory physical address of the predefined range provided to each said operation functions so as to define said storage area corresponding to each said operation function.

4. The control mechanism as claimed in claim 1, wherein said logic unit defines the storage capacity of said storage area by adjusting the memory physical address of the predefined range.

5. The control mechanism as claimed in claim 1, wherein said memory module is a storage media made of flash memory.
